(19) United States
(12) Patent Application Publication
(10) Pub. No.: US 2025/0040643 A1
(43) Pub. Date: Feb. 6, 2025

(54) CBRN PROTECTIVE CLOTHING WITH PARTIALLY FOLDABLE HOOD

(71) Applicant: PAUL BOYE TECHNOLOGIES, LABARTHE-SUR-LEZE (FR)

(72) Inventors: Marion LAMBICA, REVEL (FR); Julie DOUX, MIREMONT (FR); Hafida MARQUIER, BALMA (FR)

(21) Appl. No.: 18/927,878

(22) Filed: Oct. 26, 2024

Related U.S. Application Data
(63) Continuation-in-part of application No. PCT/EP2023/055600, filed on Mar. 6, 2023.

(30) Foreign Application Priority Data
Mar. 7, 2022 (FR) 2201967

(51) Int. Cl. A42B 1/017; A41D 13/11

(52) U.S. Cl. CPC A42B 1/017; A41D 13/11; A41D 2400/42

(57) ABSTRACT

A protective garment to protect at least an upper portion of the user's body against effects of a contaminating agent. The garment includes a hood to cover the user's head. The hood's peripheral edge delimits an opening for the user's face. In a thickness of the hood, from an external environment towards the user's body: an outer layer configured to stop the contaminating agent, in a liquid form, having a hydrophobic and oleophobic dual characteristic, and an inner layer configured to at least one of absorb and adsorb vapours originating from the contaminating agent. Each of the outer layer and the inner layer of the hood has a peripheral edge, which are assembled so as to form the peripheral edge of the hood. The peripheral edge of the outer layer is securely assembled to the peripheral edge of the inner layer only at a lower portion.

### RELATED APPLICATIONS

This application is a continuation-in-part application of PCT/EP2023/055600 filed Mar. 6, 2023, which claims priority from French Patent Application No. 2201967 filed Mar. 7, 2022, each of which is incorporated herein by reference in its entirety.

### TECHNICAL FIELD OF THE INVENTION

The present invention relates to the field of making of garments for protection against Nuclear, Radiological, Biological and Chemical aggressions. More particularly, the present invention relates to a cap, a hood or a cowl of a CBRN protective garment, of the jacket or suit type. The invention is intended for a military application as well as for a civil application.

### BACKGROUND OF THE INVENTION

There are many types of protective garments, in particular for military use. These comprise garments for protection against CBRN risks (acronym standing for Chemical, Biological, Radiological and Nuclear). These garments cover all or part of the body of the user and are intended to protect the user against the effects of contaminating agents, whether these are of chemical, biological or other nature, in particular by avoiding contact of these contaminating agents, whether they are in the liquid, vapour or aerosol form, with the skin or mucosae of the user.

In general, a garment for protection against CBRN risks comprises at least two superposed layers of material each intended for a specific function:
a so-called outer layer intended to guarantee the non-penetration of contaminating agents in the liquid form, and
a so-called inner layer, intended to ensure the adsorption and/or the absorption of contaminating agents in the vapour form.

Various ranges of protective garments have been developed, comprising items such as, for example, jackets, trousers, suits, or cowls.

In the specific example of the jacket, or of the suit, the latter comprises in particular a hood intended to cover the head and the neck of the user, apart from his/her face. It is also possible to talk about a cap.

An example of such a protective garment is illustrated, for example, in document FR3075574A1.

Alternatively or complementarily to the hood or cap, a cowl may be used.

The prior art and the invention are described hereafter with reference, without limitation, to a hood, but the invention covers any portion of a garment or a garment itself intended to cover the head and the neck of the user (hood, cap, cowl, etc.).

In turn, the face is covered by a mask, in particular by a gas mask.

In the case where the user should wear a helmet on top of the hood, in particular a protective helmet, the hood causes discomfort for the user.

Indeed, the space between the helmet and the head of the user is very limited, some helmets are even suited to the morphology of the head of the user. The extra thickness created by the different layers and by the seams making up the hood generates compression areas which cause discomfort.

In addition, in the example of helmets suited to the morphology of the head of the user, these are generally equipped with a sighting system. If the helmet is poorly adjusted on the head because of the hood, the user can no longer be operational.

The removal of the hood off the head by the user when wearing the helmet would imply that the user would no longer be protected in particular against contaminating agents in the vapour form, which cannot be considered. The same applies to the cowl.

### OBJECT AND SUMMARY OF THE INVENTION

The present invention aims to overcome the drawbacks of the solutions proposed by the prior art, in particular those set out before.

In particular, the present invention aims to provide an effective solution allowing guaranteeing a protection of the user, when he/she is equipped with a protection kit comprising a garment, with a hood, and a helmet, against the effects of contaminating agents in any forms, at least in the liquid form or in the vapour form, while preserving comfort when wearing the hood and the helmet simultaneously.

An additional objective of the invention is that this protective garment remains simple to make.

To this end, the present invention relates to a garment for protecting at least one upper portion of the body of a user, against the effects of a contaminating agent, the protective garment comprising a hood. The protective garment is so-called CBRN protective garment.

For example, the protective garment is a jacket or a suit.

The hood allows covering the head and the neck of the user, apart from the face.

The protective garment may comprise a ventral portion, a dorsal portion which could be connected together and to the hood, and sleeves.

By “contaminating agent”, it should be understood any toxic substance in the liquid, vapour and/or aerosol form, in particular chemical and/or biological, natural and/or synthetic, such as, for example, yperite.

In particular, the protective garment is intended for a military use. It may also be intended for a civil use, for example for police, hospitals staff, firefighters.

The hood, and more generally the protective garment, comprises, in its thickness, from an external environment in which the user of the protective garment is located towards the body of the user:
a layer of material, for example a textile layer, so-called the outer layer, configured to stop the contaminating agent in the liquid form, having a hydrophobic and oleophobic dual characteristic,
a layer of material, so-called the inner layer, configured to absorb and/or adsorb the vapours originating from the contaminating agent.

In the context of the present description, by “a layer having a hydrophobic characteristic”, it should be understood a layer that tends to repel water, whether by nature or by treatment.

In the context of the present description, by “a layer having an oleophobic characteristic”, it should be understood a layer that tends to repel oils, whether by nature or by treatment.

Each of the outer layer and the inner layer of the hood comprises a peripheral edge defining an opening intended for the passage of the face of the user.

Thus, the invention provides a garment for protecting at least an upper portion of the body of a user, against the effects of a contaminating agent, the protective garment comprising a portion intended to cover the head of the user, in particular a hood intended, the hood:
comprising a peripheral edge which delimits an opening intended for the passage of the face of the user;
and comprising, in its thickness, from an external environment in which the user of the protective garment is located towards the body of the user:
   a first layer of material, so-called the outer layer, configured to stop the contaminating agent in the liquid phase,
   a second layer of material, so-called the inner layer, configured to absorb and/or adsorb vapours originating from the contaminating agent,
      wherein each of the outer layer and the inner layer of the hood has a peripheral edge, which are assembled so as to form said peripheral edge of the hood, and wherein the peripheral edge of the outer layer is securely assembled to the peripheral edge of the inner layer only at a lower portion.

The concepts of lower portion and upper portion are defined with reference to the head of the user or wearer of the hood whose upper end consists of the top of his/her skull.

In other words, the inner layer and the outer layer are bonded together irreversibly, for example by sewing, at the lower portion of their respective peripheral edges, but are independent of each other over the remaining portion of their respective peripheral edges.

Still in other words, at least along an upper portion or top portion of the opening, the outer layer and the inner layer of the hood are not securely assembled irreversibly. They are reversibly assembled.

Such an invention allows reducing the thickness of the hood, by removing or folding over the outer layer at least partially, which considerably improves comfort of the user and enables a better adjustment of the helmet and, consequently, also a better sighting for the user, when the helmet is equipped with a sighting system.

The invention also enables the user wearing the garment to be able to fold over and put on again the outer layer each time he/she wishes so.

When the user wears a helmet, the lower portion of the peripheral edge of the outer layer corresponds, for example, to the portion of the peripheral edge of the outer layer that is not protected by the helmet of the user.

For example, this lower portion of the peripheral edge of the outer layer corresponds to a portion of the peripheral edge intended to be located under the ears of the user, at the level of the submandibular region, when the hood is worn by the user in the assembled configuration, also so-called the closed configuration, (the inner layer and the outer layer worn over the head and superposed substantially edge-to-edge).

The outer layer of the hood is not entirely removed, which allows preserving the protection against the contaminating agent in the liquid form between the bottom of the helmet and the ventral and dorsal portions of the garment, in particular at the level of the neck.

According to particular embodiments, the protective garment according to the invention also comprise the following features, implemented separately or in any of their technically-feasible combinations.

In some embodiments of the invention, the inner layer comprises, at its peripheral edge, a first system for tightening the opening.

When the user closes the hood around a gas mask, the first system for tightening the opening allows ensuring an adjustment of the opening according to the size of the gas mask, and exerting a tension around the gas mask.

Thus, the invention allows ensuring total sealing at the interface between the gas mask and the inner layer of the hood, so as to effectively prevent the propagation of chemical agents in the vapour form.

In some embodiments of the invention, the outer layer comprises, at its peripheral edge, a second system for tightening the opening.

When the user superposes the outer layer over the inner layer, the second system for tightening the opening allows pressing the peripheral edge of the outer layer against or proximate to the peripheral edge of the inner layer.

Thus, at the interface between the peripheral edge of the inner layer and the peripheral edge of the outer layer, the invention allows ensuring total sealing so as to effectively prevent the passage of the contaminating agent, whether it is in the liquid or vapour form, between the peripheral edges of the inner and outer layers.

In some embodiments of the invention, the second opening tightening system comprises an elastic tightening cord.

In some embodiments of the invention, each of the outer layer and the inner layer comprises, at their respective peripheral edge, reversible members cooperating for fastening thereof to one another.

The cooperating reversible members are distributed over all or part of the remaining part of the peripheral edges of the inner and outer layers.

For example, the reversible members cooperating for fastening thereof together are in particular of the hook-and-loop type.

In some variants, the outer layer has a dimension smaller than that of the inner layer. When the outer layer is brought back over the inner layer, the outer layer is retained tightly over the inner layer.

Thus, at the interface between the peripheral edge of the inner layer and the peripheral edge of the outer layer, the invention allows ensuring total sealing so as to effectively prevent the passage of the contaminating agent, whether it is in the liquid or vapour form, between the peripheral edges of the inner and outer layers.

In some embodiments of the invention, the inner layer may be covered, at the level of its peripheral edge, with a layer of material configured to stop the contaminating agent in the liquid form, having a hydrophobic and oleophobic dual characteristic.

Thus, if the peripheral edge of the outer layer is slightly offset from the peripheral edge of the inner layer, for example upon some movements of the head of the user, the user would always remain protected against the propagation of the contaminating agent in the liquid form. For example, the layer of material used to cover the peripheral edge of the inner layer is identical to the outer layer.

In some embodiments of the invention, the hood may comprise a third layer of material, so-called the intermediate layer, configured to stop the contaminating agent in the aerosol form, the intermediate layer being securely bonded to the inner layer.

Thus, the outer layer may be folded over at the nape of the user, independently of the inner layer and of the intermediate layer.

In some embodiments, the intermediate layer may be securely assembled to the peripheral edge of the inner layer, or be laminated over an outer surface of the inner layer, or form an integral portion of the inner layer.

In some embodiments, the intermediate layer may be securely assembled to the peripheral edge of the outer layer, or be laminated over an inner surface of the outer layer, or form an integral portion of the outer layer. In this type of embodiments, when the outer layer is folded over at the nape of the user, the intermediate layer is also folded over, independently of the inner layer.

The inner layer and the outer layer of the hood may be securely bonded together behind the head of the user, from their peripheral edges.

The inner layer and the outer layer of the hood may be securely bonded together behind the head of the user, at ends of the lower portion of the peripheral edges.

When the hood is worn by the user, in the assembled configuration, the lower portion of the peripheral edge of the outer layer may correspond to a portion of the peripheral edge intended to be located under the cars of the user, at the submandibular region of the user.

The invention also provides an individual protection kit wherein it comprises a protective garment according to the invention and a helmet for protecting the head of the user which directly covers, at least partially, the inner layer of the hood.

In such an individual protection kit, the lower portion of the peripheral edge of the outer layer corresponds to a portion of the peripheral edge of the outer layer that is not protected by the helmet of the user.

The invention also provides a method for protecting a user by means of an individual protection kit comprising a protective garment according to the invention and a helmet for protecting his/her head, wherein, when he/she wears the hood and wishes to put on his/her helmet, the user:
partially detaches the outer layer of the inner layer which remain assembled together at said lower portion;
folds over the outer layer towards his/her nape independently of the inner layer;
then puts on his/her helmet which is then worn on top of the inner layer.

In such a method:
when the user wears a helmet, said lower portion of the peripheral edge of the outer layer corresponds to a portion of the peripheral edge of the outer layer that is not protected by the helmet of the user;
said lower portion of the peripheral edge of the outer layer corresponds to a portion of the peripheral edge located under the ears of the user, at the level of his/her submandibular region.

### BRIEF DESCRIPTION OF THE FIGURES

The invention will be better understood upon reading the following description, given as a non-limiting example, and made with reference to the following figures:

FIG. 1 shows, in side view, a user wearing a protective garment, with a hood, according to an embodiment of the invention, which hood is worn according to a so-called assembled configuration;

FIG. 2 shows, in side view, two illustrations of the progressive folding, towards the nape of the user, of an outer layer of the hood of the protective garment of FIG. 1, the hood being worn in the so-called partially assembled configuration;

FIG. 3 shows, in side view, two illustrations of the user wearing an individual protection kit according to an embodiment of the invention, this kit being composed of a protective garment according to the invention with a hood worn in the partially assembled configuration, i.e. with the outer layer of the folded hood of FIG. 2, and a helmet worn on top of the inner layer of the hood;

FIG. 4 shows, in side view, two illustrations of the progressive folding, towards the neck of the user, of an inner layer of the hood of FIG. 2.

In these figures, identical reference numerals from one figure to another refer to identical or similar elements. Moreover, for clarity, the drawings are not plotted to scale, unless stated otherwise.

### DETAILED DESCRIPTION OF SOME EMBODIMENTS

The invention will be described in the particular context of one of its preferred fields of application wherein the CBRN protective garment is a protective jacket, intended in particular for military use or for civil use.

The invention is primarily intended, without this limiting the invention, to any person who might have to use such a protective jacket in the context of his/her professional activity, such as, for example, a military, a gendarme, a policeman/policewoman, a firefighter.

Such a protective jacket 10 is intended to protect the top of the body of the user wearing it, in particular when said user should move in an external environment contaminated by contaminating agents, such as, for example, chemical and/or biological agents.

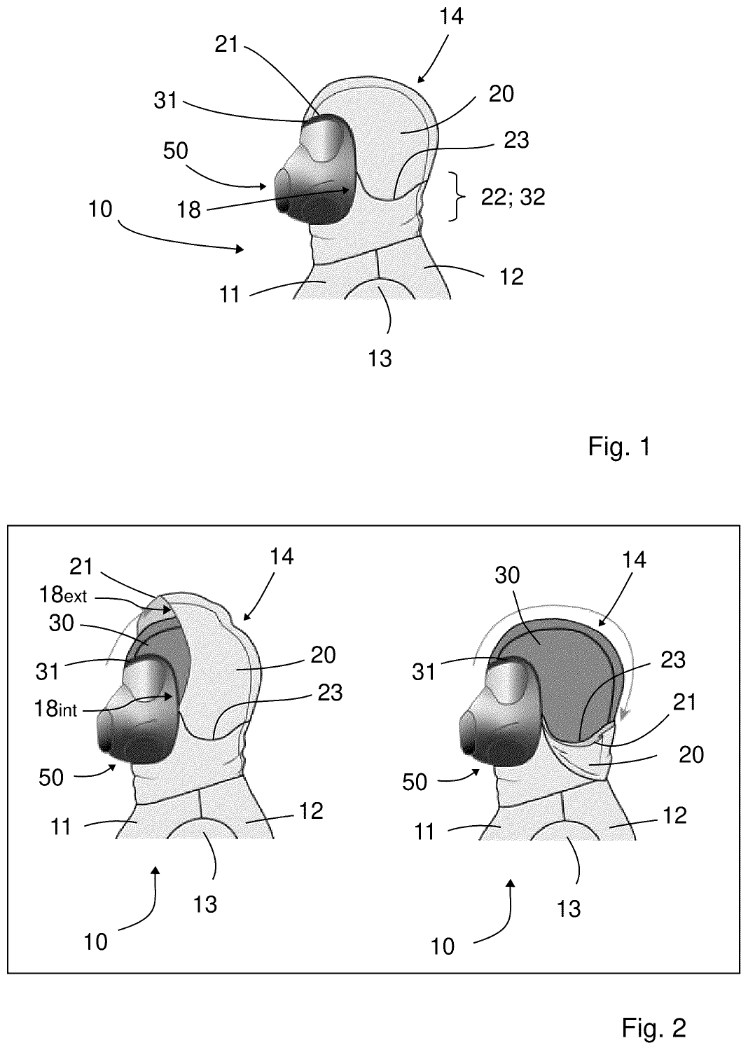

As illustrated in FIGS. 1 to 4, the protective jacket 10 comprises a ventral portion 11, intended to be arranged at the front of the body of the user, i.e. at the level of his/her torso, and an opposite dorsal portion 12, intended to be arranged at the back of the user.

The protective jacket 10 herein comprises two sleeves 13 (one single sleeve is shown in the figures), each intended to be arranged respectively at an arm of the user.

The protective jacket 10 further comprises a hood 14, intended to be arranged at the level of the head of the user, covering the head, apart from the face, and the neck.

When the hood is deployed over the head of the user and in the assembled configuration, the face of the user opens throughout a face opening 18 of the hood (cf. FIG. 1).

The hood 14 has a peripheral edge which, when the hood 14 is deployed over the head of the user, delimits the opening 18 intended for the passage of the face of the user, equipped in particular with the gas mask 50.

Without limitation, the opening 18 has a continuous periphery.

In a known manner, the periphery 18 has a circular or elliptical general shape.

More precisely, in the context of CBRN protective garments, the user wears a gas mask 50 at the face. Thus, the face of the user equipped with the gas mask 50 worn by the user opens throughout the opening 18 of the hood 14.

The protective jacket comprises, in its thickness, from an external environment in which the body of the user wearing the protective jacket is located under normal conditions of use, towards the body of the user, at least:
a first layer of material, so-called the outer layer 20,
a second layer of material, so-called the inner layer 30, intended to be in direct or indirect contact with the body.

It should herein be understood that the ventral portion 11, the dorsal portion 12, the hood 14 and the sleeves 13 are all formed by the outer layer 20 and the inner layer 30.

In FIG. 1, only the outer layers 20 of the ventral portion 11, the dorsal portion 12, the hood 14 and the sleeves 13 are visible.

The outer layer 20 and the inner layer 30 are superposed and assembled together, for example by stitching, at least over the entire periphery of the ventral portion 11, the dorsal portion 12 and the sleeves 13.

The outer layer 20 is composed of a material, the main functions of which are:
on the one hand, to ensure the robustness of the protective jacket 10 by protection against external mechanical aggressions/loads, in particular resistance to abrasion and to tearing, and
on the other hand, to guarantee the non-penetration of contaminating agents in the liquid form.

Without limitation, the outer layer 20 is preferably also air-permeable.

For example, the outer layer 20 is a textile layer. For example, the outer layer 20 is composed of a woven, nonwoven or knitted textile, made of natural fibres, of synthetic fibres or of a cellular material.

For example, the outer layer 20 is made of a fine fabric, for example a fabric, made of polyester, polyamide, or a mixture with fibres such as, for example, cotton, aramid or viscose. For example, the outer layer consists of a mixture of the cotton/polyester or aramid/viscose type.

To guarantee the non-penetration of contaminating agents in the liquid form, the outer layer has a hydrophobic and oleophobic dual characteristic.

In one embodiment, this hydrophobic and oleophobic dual characteristic is generally obtained by applying, over one face of the textile, so-called the outer face, located on the side of the external environment, a hydrophobic and oleophobic treatment, such as, for example, a treatment based on fluorocarbon resins, such as, for example, Teflon®.

In another embodiment, this hydrophobic and oleophobic dual characteristic is generally obtained by coating.

For example, the outer layer 20 has a basis weight comprised between 150 and 250 g/m2, even more specifically in the range of 200 g/m2.

In turn, the inner layer 30 is composed of a material whose main function is to ensure the absorption and/or the adsorption of contaminating agents in the vapour form. In general, this absorption and/or adsorption is obtained by an adsorbent medium which captures, through an adsorption or reaction phenomenon, contaminating agents in the vapour form.

For example, the adsorbent medium is composed of activated carbons, zeolites, catalysts. For example, the adsorbent medium is integrated into the material in the form of a powder, beads or fibers.

Without limitation, the inner layer 30 is also preferably air-permeable.

For example, the inner layer 30 has a basis weight comprised between 60 and 450 g/m2, and more specifically between 200 and 350 g/m2.

In a variant embodiment, the jacket may also comprise a third layer of material (not shown in the figures), so-called the intermediate layer.

From an external environment in which the body of the user wearing the protective jacket is located under normal conditions of use, towards this body, the intermediate layer is arranged between the outer layer 20 and the inner layer 30.

In one embodiment, the intermediate layer is composed of a material whose main function is to guarantee the non-penetration of contaminating agents in the aerosol form.

For example, and without limitation, the intermediate layer is also preferably air-permeable. For example, the intermediate layer is example composed of a nonwoven textile.

To guarantee the non-penetration of contaminating agents in the liquid and vapour forms at the interface between the hood 14 and the ventral 11 and dorsal 12 portions, the hood 14 may, for example, be assembled by stitching to the ventral 11 and dorsal 12 portions, or be made in one-piece with the ventral 11 and dorsal 12 portions.

The peripheral edge of the hood 14, which delimits the opening 18, is formed by a peripheral edge 31 of the inner layer 30 and a peripheral edge 21 of the outer layer 20.

Thus, as shown in the left-side portion of FIG. 2, the peripheral edge 21 of the outer layer 20 delimits a face opening 18ext in the outer layer 20, whereas the peripheral edge 31 of the inner layer 30 delimits a face opening 18int in the inner layer 30.

In other words, the inner layer 30 of the hood 14 has a peripheral edge 31 and the outer layer 20 of the hood 14 has a peripheral edge 21, each defining an opening intended for the passage of the face of the user, when the hood 14 is worn in the assembled configuration.

As illustrated in FIG. 1, when the hood 14 is worn in the assembled configuration, the peripheral edge 21 of the outer layer 20 is substantially superposed over the peripheral edge 31 of the inner layer 30.

In existing hoods, the outer layer 20 and the inner layer 30 are securely assembled irreversibly over the entire length of their peripheral edges 21, 31, i.e. over the entire periphery of the opening 18.

According to the invention, the peripheral edge 21 of the outer layer 20 of the hood 14 is securely assembled irreversibly to the peripheral edge 31 of the inner layer 30 of the hood 14 only at a lower portion 22, 32.

By securely assembled, or securely bonded, it should be understood that the outer layer 20 and the inner layer 30 of the hood 14 are irreversibly bonded together.

The outer layer 20 and the inner layer 30 of the hood 14 are bonded together at the lower portion, preferably by stitching.

Thus, the hood 14 according to the invention differs from existing hoods wherein the outer layer 20 and the inner layer 30 are securely assembled irreversibly over their entire peripheral edge 21, 31, i.e. both along the upper portion or top portion of the opening 18 and along the lower portion or bottom portion of the opening 18.

The lower portion 22 of the peripheral edge 21 of the outer layer 20 and the lower portion 32 of the peripheral edge 31 of the inner layer 30 herein correspond to a lower portion or bottom portion of the opening 18.

With reference to the vertical orientation illustrated in the figures in which at least the torso of the user and his/her head are oriented according to the vertical corresponding to his/her standing-up position, by lower portion 22 of the peripheral edge 21 of the outer layer 20, it should be understood the bottom portion of the opening 18 which, without limitation, herein extends beneath a seam 23.

Similarly, by upper portion of the peripheral edge 21 of the outer layer 20, it should be understood the top portion of the opening 18 which, without limitation, herein extends over the seam 23.

For example, the lower portion 22 of the peripheral edge 21 of the outer layer 20 corresponds, when the user wears a helmet 60, to the portion of the peripheral edge 21 of the outer layer 20 that is not protected by the helmet 60 of the user.

In one embodiment, the lower portion 22 of the peripheral edge 21 of the outer layer 20 corresponds to a portion of the peripheral edge intended to be located under the ears of the user, at the level of the submandibular region, when the hood is worn by the user in the assembled configuration.

Thus, the inner layer 30 and the outer layer 20 are bonded together so as to be able to be offset relative to one another:
from a fully assembled configuration, in which the outer layer is completely superposed with the inner layer, in other words in which both the outer layer and the inner layer are deployed over the head of the user substantially over the same length and the same width;
to a partially assembled configuration, in which the outer layer is substantially less deployed over the head of the user than the inner layer, or is folded over at the level of the neck of the user, while being retained with the inner layer only at the lower portion 22, 32 of their peripheral edge 21, 31.

In other words, in the fully assembled configuration, the upper portion of the peripheral edge 21 of the outer layer 20 is superposed with, or positioned proximate to, the upper portion of the peripheral edge 31 of the inner layer 30.

In the partially assembled configuration, the upper portion of the peripheral edge 21 of the outer layer 20 is dissociated from the upper portion of the peripheral edge 31 of the inner layer 30 and the outer layer 20 may be folded over, independently of the inner layer 30.

The outer layer 20 may be folded over at up to the neck of the user, when the user wears the hood in the partially assembled configuration.

Thus, the outer layer 20 is movable between:
a deployed position which is illustrated in FIG. 1 and in which, with the inner layer 30 to which it is assembled over the entire length of the peripheral edge of the opening 18, the outer layer 20 extends around the head of the user apart from his/her face (the hood in the assembled configuration); and
a partially folded over position which is illustrated in the right-side of FIG. 2 and in which the folded portion of the outer layer 20 is arranged behind the head of the user, generally at the level of his/her neck, his/her nape.

This is what is meant by the expression “partially foldable hood”.

The inner layer 30 and the outer layer 20 are herein securely bonded together behind the head, from their peripheral edges. In one embodiment, the inner layer 30 and the outer layer 20 are bonded together at the level of the ends of the lower portion of the peripheral edges. For example, the inner layer 30 and the outer layer 20 are securely bonded by a seam 23, as illustrated in FIG. 1.

For example, when the user wears the hood 14, the inner layer 30 and the outer layer 20 of the hood 14 are securely bonded at the level of the occiput of the head of the user.

When the user wears the hood 14, the secure connection, behind the head, between the inner layer 30 and the outer layer 20 of the hood 14 is located above the peripheral edge of the outer layer 20, when the outer layer is folded over. Thus, even when the outer layer is folded over, and the helmet 60 is put on, the user is protected, between the portion located under the helmet 60 and the folded outer layer 20.

In a preferred embodiment (not shown), the inner layer 30 may be covered, at the level of its peripheral edge 31, with a layer of material configured to stop the contaminating agent in the liquid form, having a hydrophobic and oleophobic dual characteristic. Thus, should the peripheral edge 21 of the outer layer 20 be slightly offset from the peripheral edge 31 of the inner layer 30, for example following some movements of the head of the user, the user would nevertheless remain protected, between the two peripheral edges 21, 31, against the propagation of the contaminating agent in the liquid form. For example, the layer of material used to cover the peripheral edge 31 of the inner layer 30 is similar to the outer layer.

In the variant wherein the protective jacket comprises the intermediate layer, configured to stop the contaminating agent in the aerosol form, this intermediate layer is, for example, securely assembled to the inner layer.

For example, the intermediate layer may be securely assembled to the peripheral edge 31 of the inner layer 30, or be laminated over an outer surface of the inner layer 30, or be an integral portion of the inner layer 30.

By “outer surface” of the inner layer 30, it should be understood the surface of the inner layer that is opposite to a surface of the inner layer facing, or in contact with, the head of the user. Thus, in the partially assembled configuration, the upper portion of the peripheral edge 21 of the outer layer 20 is dissociated from the upper portion of the peripheral edge 31 of the inner layer 30 and of the intermediate layer.

The outer layer 20 may be folded over, independently of the inner layer 30 and of the intermediate layer.

Alternatively, the intermediate layer may be assembled to the outer layer 20. For example, the intermediate layer may be securely assembled to the peripheral edge 21 of the outer layer 20, or be laminated over an inner surface of the outer layer 20, or form an integral portion of the outer layer 20. By “inner surface of the outer layer 20”, it should be understood the surface facing the outer surface of the inner layer 30. Thus, in the partially assembled configuration, the outer layer 20 and the intermediate layer may be folded over together, independently of the inner layer 30.

The inner layer 30 of the hood 14 comprises, at the level of the peripheral edge 31, a system for tightening the opening, so-called the first tightening system (not shown in the figures).

The first tightening system allows exerting a tension around the gas mask 50 of the user, when the hood 14 is closed, and ensuring an adjustment of the circumference of the opening according to the size of the gas mask.

In one embodiment of the first tightening system, this first system for tightening the opening is an elastic tightening cord. For example, the elastic tightening cord may be inserted into a receiving channel, for example formed by stitching starting from the inner layer. The elastic tightening cord, for example a flat elastic, has, for example, a length smaller than the circumference of the opening 18.

In another embodiment of the first tightening system, the tightening cord is a cord, elastic or not, inserted into a receiving channel, for example formed by stitching starting from the inner layer 30. The two free ends of the cord come out of the receiving channel, via two eyelets formed in the receiving channel, and which can be grasped and pulled by the user to reduce the length of the cord in the receiving channel, thereby reducing the circumference of the opening. Blocking means, of the blockers type, for example, are associated with the cord, to keep the desired length of the cord in the receiving channel.

Thus, when the user closes the hood around his/her gas mask 50, the user tightens the tightening cord of the inner layer 30 around the gas mask 50, by reducing the length of the tightening cord, and consequently reduces the circumference of the opening 18, so as to adapt to the size of the gas mask.

In one embodiment, to keep the outer layer 20 against the inner layer 30 of the hood, and to prevent the penetration of the contaminating agent, in any form whatsoever, between the peripheral edges of the two layers 20, 30, the outer layer 20 has a dimension smaller than the inner layer.

Thus, when the outer layer 20 is brought back over the inner layer 30, the outer layer 20 is tightly retained on top of the inner layer 30.

Alternatively, to keep the outer layer 20 against the inner layer 30 of the hood 14, and to prevent the penetration of the contaminating agent, in any form whatsoever, between the peripheral edges of the two outer 20 and inner 30 layers, the outer layer 20 of the hood 14 comprises, at the level of its peripheral edge 21, a system for tightening the opening, so-called the second tightening system (not shown in the figures).

The second tightening system allows exerting a tension on the inner layer 30, at the level of its peripheral edge 31, when the hood 14 is closed.

In one embodiment of the second tightening system, the second tightening system is an elastic tightening cord. For example, the elastic tightening cord may be inserted into a receiving channel, for example formed by stitching starting from the inner layer. The elastic tightening cord, for example a flat elastic, has, for example, a length smaller than the circumference of the opening.

Alternatively, to hold the outer layer 20 against the inner layer 30 of the hood, and prevent the penetration of the contaminating agent, in any form whatsoever, between the peripheral edges of the two layers 20, 30, each of the outer layer 20 and the inner layer 30 comprises, at the level of their respective peripheral edge 21, 31, the lower portion 22, 32 being excluded, cooperating reversible members for fastening them together.

The cooperating reversible members may be distributed over all or part of the peripheral edge of the inner layer 30 and that of the outer layer 20, the lower portion 22, 32 being excluded. For example, the cooperating reversible members are distributed over the entirety of the upper portion of the peripheral edge of the inner layer 30 and of the upper portion of the peripheral edge of the outer layer 20 which delimit the top portion of the opening 18.

In one embodiment, the cooperating reversible members are of the hook-and-loop type, also so-called self-gripping strip, and in particular commercialised under the brand Velcro®.

FIGS. 1 to 4 illustrate different examples of use of the protective jacket and of its hood, with or without a helmet. In these different figures, the hood 14 comprises the inner layer 30 and the outer layer 20.

FIG. 1 illustrates the example of a user wearing only the hood 14 and a gas mask 50, i.e., without a helmet.

The user is wearing the hood 14 in the assembled configuration, the peripheral edge 21 of the outer layer 20 is then superposed with the peripheral edge 31 of the inner layer 30.

Thanks to the first tightening system, the peripheral edge 31 of the inner layer 30 is kept tightened against the gas mask 50 of the user. The peripheral edge 21 of the outer layer 20 is tightly bonded to the peripheral edge 31 of the inner layer 30, in order to prevent the penetration of the contaminating agent, in any form whatsoever, between the two layers 20, 30. Each of the two layers has its role in protecting together the user against CBRN risks.

When the user wishes to wear a helmet 60, while keeping his/her hood 14, the outer layer 20 is partially disassembled beforehand off the inner layer 30 and folded over towards the nape of the user.

The outer layer 20 and the inner layer 30 of the hood 14 are then in the partially assembled configuration.

The peripheral edge 21 of the outer layer 20 is brought away from the peripheral edge 31 of the inner layer 30 and the outer layer 20 is folded over at the level of the nape of the user. The two illustrations of FIG. 2 illustrate the progressive folding over of the outer layer 20 towards the nape. The peripheral edge 31 of the inner layer 30 is always kept tightened, by the first tightening system, against the gas mask of the user.

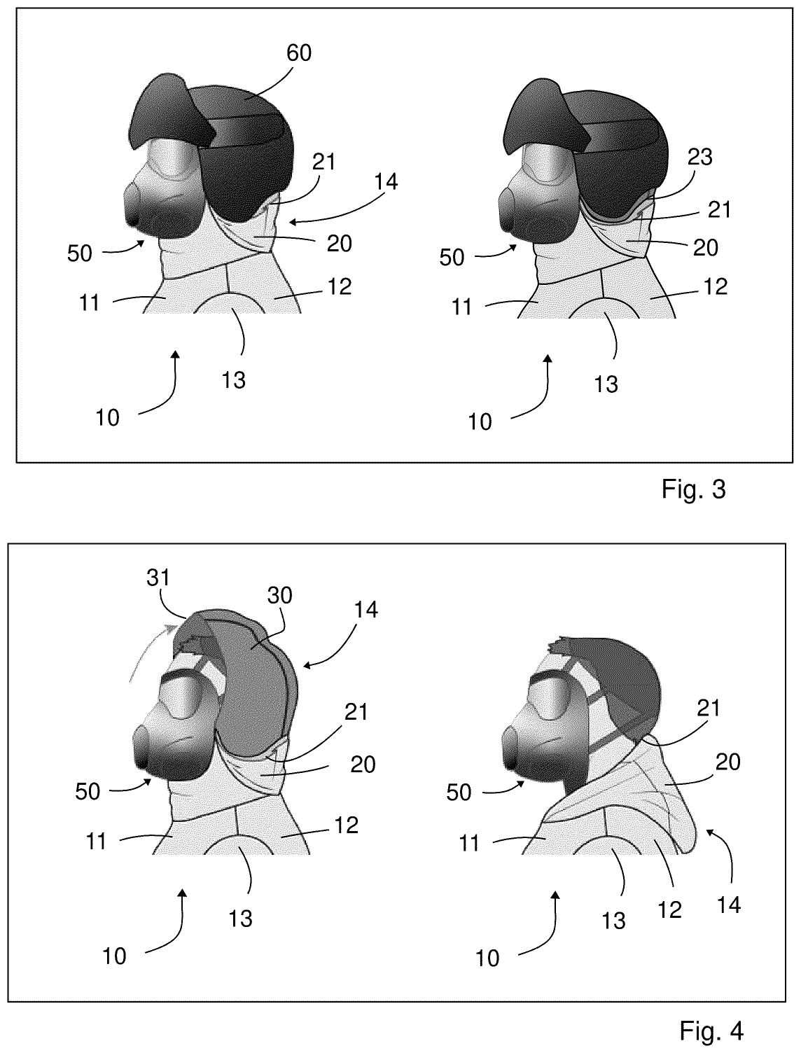

FIG. 3 illustrates the user with his/her helmet 60, and the outer layer 20 folded over.

The helmet 60 is then worn on top of the inner layer 30 which is interposed between the head of the user and the inside of the helmet 60.

The helmet 60 for protecting the head of the user then directly covers, at least partially, the inner layer 30 of the hood 14.

The left-side illustration of FIG. 3 shows the bottom of the helmet 60 overlapping the seam 23 (non-visible seam). The right-side illustration of FIG. 3 shows the bottom of the helmet 60 when not overlapping the seam 23 (visible seam), but located proximate to the latter.

The user continues to be protected against CBRN risks, the helmet 60 then acting as a protection against the contaminating agent in the liquid phase, thereby ensuring the role of the outer layer 20. Having one layer less over the head considerably improves the comfort of the user when he/she wears his/her helmet 60, and enables him/her to remain operational (when the helmet is equipped with a sighting system), while guaranteeing to him/her a complete protection against CBRN risks.

The fact that the outer layer 20 of the hood 14 cannot be completely put off advantageously avoids the user losing it and allow maintaining the protection against the contaminating agent in the liquid form between the bottom of the helmet 60 and the ventral 11 and dorsal 12 portions of the garment, in particular at the level of the nape.

When the user puts off his/her helmet 60, the user can immediately return the outer layer 20 over the head and replace the outer and inner layers 20, 30 of the hood 14 in the fully assembled configuration, in which they are superposed.

When the user wishes to put off his/her hood 14 (in other words, completely fold over the hood 14), the first tightening system is loosened and the inner layer 30 is folded over towards the nape. The two illustrations of FIG. 4 illustrate the progressive folding over of the inner layer 30 towards the nape. Afterwards, the user can remove his/her gas mask 50.

The description hereinabove clearly illustrates that, thanks to its different features and their advantages, the present invention achieves the objectives that it has set. In particular, the invention provides a protective garment with a hood which enables the user, when he/she should wear a helmet 60 on top of the hood, to continue to be protected against CBRN risks, while guaranteeing comfort for the user.

The hood also allows ensuring a good interface between the inner layer and the outer layer. By “good interface”, it should be understood an interface capable of ensuring total sealing between said two inner and outer layers so as to effectively prevent the propagation of the contaminating agent in all possible forms.

The protective garment is described in the preferred example of a protective jacket, but it may also be in the form of a suit protecting at least one upper portion of the body. All of the features described hereinabove for the jacket could be adapted to the suit.

The features of the hood may also be adapted to a cowl, in all of the possible combinations described hereinbefore.

1. A protective garment to protect at least an upper portion of a body of a user against effects of a contaminating agent, the protective garment comprising a hood configured to cover a head of the user, the hood comprising:
a peripheral edge which delimits an opening for a passage of a face of the user; and
in a thickness of the hood, from an external environment in which the user of the protective garment is located towards the body of the user:
a first layer of material, referred to as an outer layer, configured to stop the contaminating agent, in a liquid form, having a hydrophobic and oleophobic dual characteristic;
a second layer of material, referred to as an inner layer, configured to at least one of absorb and adsorb vapours originating from the contaminating agent;
wherein each of the outer layer and the inner layer of the hood has a peripheral edge, which are assembled so as to form the peripheral edge of the hood; and
wherein the peripheral edge of the outer layer is securely assembled to the peripheral edge of the inner layer only at a lower portion.

2. The protective garment of claim 1, further comprising a first tightening system to tighten the opening at the peripheral edge of the inner layer.

3. The protective garment of claim 2, further comprising a second tightening system to tighten the opening at the peripheral edge of the outer layer.

4. The protective garment of claim 3, wherein the second tightening system comprises an elastic tightening cord.

5. The protective garment of claim 1, wherein each of the outer layer and the inner layer comprises, at their respective peripheral edge, reversible members cooperating for fastening thereof to one another.

6. The protective garment of claim 1, wherein the inner layer is covered, at its peripheral edge, with a layer of material configured to stop the contaminating agent in the liquid form, having a hydrophobic and oleophobic dual characteristic.

7. The protective garment of claim 1, wherein the hood comprises a third layer of material, referred to as an intermediate layer, configured to stop the contaminating agent in an aerosol form, the intermediate layer being securely bonded to the inner layer.

8. The protective garment of claim 1, wherein the inner layer and the outer layer are securely bonded together behind the head of the user, from their peripheral edges.

9. The protective garment of claim 8, wherein the inner layer and the outer layer are securely bonded together behind the head of the user at ends of the lower portion of the peripheral edges.

10. The protective garment of claim 1, wherein, when the hood is worn by the user and is closed, the lower portion of the peripheral edge of the outer layer corresponds to a portion of the peripheral edge of the outer layer configured to be located under ears of the user, at a submandibular region of the user.

11. An individual protection kit comprising the protective garment of claim 1 and a helmet to protect the head of the user which directly covers, at least partially, the inner layer of the hood.

12. The individual protection kit of claim 11, wherein the lower portion of the peripheral edge of the outer layer corresponds to a portion of the peripheral edge of the outer layer that is not protected by the helmet of the user.

13. A method for protecting a user by an individual protection kit comprising a protective garment of claim 1 and a helmet to protect the head of the user, wherein, when the user wears the hood and wishes to put on the helmet, the user:
partially detaches the outer layer from the inner layer which remain assembled together at the lower portion;
folds over the outer layer, independently of the inner layer, towards a nape of the user; and
puts on the helmet which is then worn on top of the inner layer.

14. The method for protecting the user of claim 13, wherein, when the user wears the helmet, the lower portion of the peripheral edge of the outer layer corresponds to a portion of the peripheral edge of the outer layer that is not protected by the helmet of the user.

15. The method for protecting the user of claim 14, wherein the lower portion of the peripheral edge of the outer layer corresponds to a portion of the peripheral edge located under cars of the user, at a level of a submandibular region of the user.
